(19) United States
(12) Patent Application Publication
(10) Pub. No.: US 2008/0167859 A1
(43) Pub. Date: Jul. 10, 2008

(54) Definitional method to increase precision and clarity of information (DMTIPCI)

(76) Inventor: Stuart Allen Garrie, Bellevue, WA (US)

Correspondence Address: Stuart Allen Garrie, 113 Cedar Crest Lane, Bellevue, WA, 98004, US

(21) Appl. No.: 12/006,552

(22) Filed: Jan. 2, 2008

Related U.S. Application Data
(60) Provisional application No. 60/878,628, filed on Jan. 4, 2007.

(51) Int. Cl. G06F 17/27

(52) U.S. Cl. 704/10

(57) ABSTRACT

The “Definitional Method To Increase Precision And Clarity of Information (DMTIPCI)” solves the problem of knowing precisely and clearly what predicate terms mean using the following processes: 1. The process of repeatedly defining the predicate terms' meanings in definitions until the primary words of original predicates are found. 2. The process of using concrete examples to understand the primary words' meaning. 3. A list primary words in language derived by the DMTIPCI processes. 4. The process of using the primary words as a classificatory system for knowledge. And 5. The process of improving search engine technologies as to precision and clarity of meaning plus as to new ways of understand customer interest.

### CROSS-REFERENCE TO RELATED APPLICATIONS

U.S. patent documents: Not Applicable

Other References:
1. Oxford English Dictionary Online, Copyright© Oxford University Press 2007, U.S.
2. Merriam-Webster Unabridged Dictionary CD, Ver. 2.5, Copyright© Merriam-Webster Inc. 2000, U.S.
3. MILLER, GEORGE A., The Science of Words, ©1996, pp. 1-271, Scientific American Library, N.Y.
4. MARITAIN, JACQUES, An Introduction to Philosophy, pp. 101-271, Sheed & Ward, Inc., 63 Fifth Avenue, New York.
5. RODERICK, M. CHISHOLM, Theory of Knowledge, ©1966, pp. 1-115, Prentice-Hall, Inc., Englewood Cliffs, N.J., U.S.
6. ALSTON, WILLIAM P., Philosophy of Language, © 1964, pp. 1-113, Prentice-Hall, Inc., Englewood Cliffs, N.J., US.
7. COBLEY, PAUL AND JANSZ, LITZA, Introducing Semiotics, ©1997, pp. 1-175, Allen and Unwin Pty. LTD., PO Box 8500, 83 Alexander Street, Crows Nest, NSW 2065.
8. SERGEY BRIN AND LAWRENCE PAGE, The Anatomy Of a Large-Scale Hypertextual Web Search Engine, Computer Science Department, Stanford University, Stanford, Calif. 94305, Web site—infolab.stanford.edu/˜backrub/google.html.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

1. Classification Definitions: Dictionary building—704/10; Natural Language—704/9; Data processing software development—715.

2. Subject Matter: Semantics or the Meaning of Words. Current dictionaries, Oxford English Dictionary (OED) or Merriam-Webster Unabridged Dictionary (MWUD), indicate the historical word usage to establish the definition of a word or meaning (see Other References). Similarly the Google search engine is based on page-ranking by historical usage (see Other References). The problem with only defining words by historical usage is that after the various usage definitions are given, one still has the problem of what the terms in the predicate of those usage definitions means. For example, the word hot-dog in the OED online is defined as follows by historical usage: A hot-dog is “a hot sausage enclosed as a sandwich in a bread roll.” A hot-dog is “expressing delight or strong approval.” One still needs to defining the predicate terms following “is.” This prior art or technology does not give processes to precisely and clearly give the meaning of predicate terms. Since the problem has existed for thousands of years, its solution does not appear to be obvious.

### BRIEF SUMMARY OF THE INVENTION

Usefulness: For any sentence we speak to be intelligible to others, both speaker and hearers must take basic ideas for granted such as that the words in the sentence mean the same thing to us both; if we do not, we are in a world where nothing is intelligible. This DMPTICI invention has new processes for creating and/or testing the clarity and precision of informational processes and knowledge claims. Informational processes are dictionaries, digital and/or paper word classification systems, any online data primary/search engine, and language or the exchange and understanding of words between two or more people.

Also DMPTICI's constructive processes are new means of classification of knowledge. The DMPTICI's definitional method allows one to go in the opposite direction and construct definitions of words from the primary words (e.g. search engine primary words used as classification system), see the primary word list attached appendix list A.

New and Unique: The DMPTICI process keeps the definition of words in a sentence's predicate on a sound footing by analyzing the predicate's words or terms down to their roots, herein referred to as “primary words,” and then building the definitions of the predicate words through the now understood primary words which compose the predicate terms of the subject's definition. Thus a precise and agreed to meaning can be achieved for each historically defined subject; i.e. agreed to on the basis of the fact that we know the origin of the meanings of the words in the built up definitions of the subject's predicate under discussion or debate.

### DETAILED DESCRIPTION OF THE INVENTION

DMTIPCI Methods: Processes or steps to develop a clear understanding and precision of knowledge in defining words:

The DMTIPCI discovers words or meanings that cannot be defined by other words. A word is vocal or written sign of a meaning. A word is also called a signifier; it signifies a meaning. Meanings are what we can know; objects we perceive, remember, imagine, or conceptualize. A meaning or a word is a “primary” word if it cannot be described by other words (predicate). A non-primary meaning or word is definable if it can be described by other words. A primary meaning or word can only be defined (understood) by examples.

Take any word from the above listed informational processes such as dictionaries, digital and/or paper word classification systems, words exchanged between two or more people, etc. Then execute the second part of the DMTIPCI process by noting the words in the predicate of a statement of information from the previously mentioned fields of knowledge, i.e. the subject's properties. One then proceeds to define each property (word-meaning) in the predicate; then this is repeated again for each word's predicate of those words in the previous predicate until there are no predicate words left that can be defined by other words.

For example, take the definition “apple.” Several definitions are given in dictionaries and I have selected two. According to the Merriam-Webster Unabridged Dictionary (MWUD), an apple is “the pome fruit of the genus Malus . . . ” And a “pome fruit” is “a fleshy accessory fruit . . . ” One of the definitions of apple in the Oxford English Dictionary (OED) is “The round firm fleshy fruit of a Rosaceous tree (Pyrus Malus) . . . . ” According to the DMTIPCI processes one proceeds to examine the properties listed in the predicate. One central property in the predicate of the definition for apple is “fruit.” According to one definition in the MWUD, a fruit is “a product of a plant growth useful to man or animal.” One of the Oxford English Dictionary definitions of a fruit is “the edible product of a plant or tree, consisting of the seed and its envelope.” Following this provisional patent's claims for the DMTIPCI, the properties of “fruit” are then defined. Both the MWUD and the OED definitions of fruit include the word “product.” According to one of the MWUD definitions, a product is “a substance produced from one or more other substances as a result of chemical changes.” Again following DMTIPCI, one of the MWUD definitions of “produce” is “give being, form, or shape to.” According to one of the OED definitions, a “product” is “a thing produced by nature or natural processes.” According to one of the OED definitions of “produce, produce means “to bring (a thing) into existence from its raw materials or elements, or as the result of a process; to give rise to, bring about, effect, cause, make (an action, condition, etc.).” What does “to bring into existence” mean? This phrase is similar to the MWUD's “to give being, form, or shape to.” How does this predicate differ from such words as create or make? MWUD writes “make” means “to bring (a material thing) into being by forming, shaping, or altering material.” OED writes “to cause the material or physical existence of by some action.” We have come to a series of primary words for several similarly meaning words, “cause,” “bring into” and “make.” And what is produced, made, caused, or brought into existence? “A material thing” or “a physical existence,” i.e. to make, cause, bring into existence a material thing. MWUD defines “existence” as “something that exists.” OED defines existence as “the fact or state of existing.” We can see that the word being defined is being defined as itself; the subject is the predicate. The DMTIPCI has led to the primary words. Existence cannot be defined by more properties.

Can “to cause,” “to make,” or “bring into” be further defined? MWUD defines “to cause” as “to bring into existence” or “to make.” One of the definitions in the OED of “to cause” is “to effect, bring about, produce, induce, make be.” Here again the DMPTICI shows that these words basically mean have the same property(s); these properties can not be defined in terms of other properties than themselves. What about the predicate property words “shape,” “form,” “material,” or “physical?” What does the MWUD say about the word, “material?”

One definition in the MWUD is “consisting of matter.” And what is one definition in the MWUD of “matter?” One definition it gives of “matter” is “a physical substance.” One MWUD definition of physical is “of or belonging to all created existence in nature.” And the OED, one definition of “material” is “formed or consisting of matter.” Then another definition in the OED, this time of “matter” is “a thing.” One may ask what is meant by the word substance; one definition of substance in the OED is “That which underlies phenomena; the permanent substratum of things; that which receives modifications and is not itself a mode; that in which accidents or attributes inhere.” In other words substance is any “subject” which gets a predicate, whether material or non-material; or “that which” has properties. Again the second process of DMPTICI has lead us to the words that cannot be defined in terms of other words. By the DMPTICI processes, the primary words were reached: “existence” “to bring about,” “to cause,” “to make,” “substance,” “material thing,” or “matter.”

Now that the primary words in the predicate words for “apple” have been found by the DMPTICI first process. We can proceed to the second DMPTICI process which is can examples be given of the primary words, e.g. “existence?” Can examples be given of things that exist? Of course. Everything we know “exists” or we would not know it. So we can give many examples of existences, perhaps starting with ourselves; thus we learn the meaning of “being” and what it means “to exist.” To elaborate, “I am Stuart.” or “You are Mary.” These statements mean something is. What about examples of “cause” or “to bring into being?” Here are some examples of causation: “I made that table; it is made of wood and is three feet by four feet by two feet high.” “You caused the bat to hit my arm and the bat hitting my arm caused my arm to break.” “You made a cake from the ingredients.” What about the word “material.” What is a material thing? Anything that possesses extension or dimensions: Me, You, it, that ball, this cake. What is a “non-material” thing? My father is dead, but I have a “memory” of him in my “mind.” The mind consists of percepts, imaginings (pink elephants that fly), memories, and concepts—in other words, all are representations non-material substances.

As one can understand from the above example, part of the process to increase clarity of a definition is to ask what the word is “not.” This was done above with the primary word “material” and its contrary, “non-material.” Regarding the primary word, “existence,” one could have asked, what does it mean to not exist? Aristotle has written that a thing ceases to exist when it loses its essential property, e.g. a person's essential property may be defined as “the ability to think;” and when a person loses that property, that person, who was a person, is not a person anymore. When does an apple become not an apple? Since it is a fruit and a fruit is an edible product of a plant or tree, then if being a fruit is its essential trait or property, when it is not edible it is not a fruit and thus not an apple. So when an apple becomes inedible it is not an apple, it is another existence. We may or may not have a term for the negative of a word. In the case of a person, a non-person is called a corpse after it loses its essential property; as to an apple, without a separate word, we could call it “an inedible apple” as we might call a dead human being a “dead person” instead of a corpse. A corpse is not really a person anymore and an inedible apple is not an apple.

Dictionaries such as the OED often list synonyms and antonyms of the primary word they are defining; antonyms being what the word is not. But these dictionaries to not use the DMPTICI process of deconstructing their definition's predicate to the primary words. These dictionaries also give the various definitions of their words by historical usage or context. For example the phrase “apple of my eye” uses the word “apple” in a way that changes its meaning from the meaning discussed above. But this change in definition does not prevent the execution of the DMPTICI processes on the new predicate terms. Often historically new predicates for words are created by the public. This does not change the validity of the DMPTICI processes nor its purposes of increasing the precision and clarification of a word's meanings.

The above example of the DMPTICI processes, defining some of the predicate terms of the word “apple,” is a new method of clarification and more precise understanding of information. DMPTICI shows how to deconstruct a subject's predicate terms to primary terms. Then once the predicate terms of the subject are broken down to the point of their primary words; the subject, e.g. an apple, can be clearly and precisely described.

List of primary words derived by the DMTIPCI: A unique list of primary words derived by the DMTIPCI processes of deconstrution is attachment Appendix A. These words or signifiers can only be defined or understood according to the DMPTICI example process. For clarification, a few of the basic primary words are here discussed. These primary words can be used in the second set of DMPTICI processes which develops a new way of classifying information.

Examples of primary words. Most primary words can be grouped under two general classes of primary words:
1. Space-Time
   a. Space which is composed two primary terms.
      1.) Position (Location or Direction)-Boundary which have sub-primary terms such as “on,” “under,” “over,” “toward,” “above,” “below,” “away,” “close,” “up,” “down,” “near,” “far,” “from-to,” “left-right” (mirror image founded on), “(often used terms establishing co-ordinates in geometries).
      2.) Extension-length which have sub-primary terms such as point, line
      Examples of extension: I am 6 feet tall. I am two feet wide.
      Length and direction are 2 components of Space.
         Units of extension or length and direction are arbitrary designations. For example, 1 cm is the length “from” here “to” there on a ruler. A fundamental unit of length.
            Examples using boundary or position words: The book was on the table and the cat was under the table.

Position-Location may be definable by other words-See below
Definition of Position or Location: Position or Location is a point above, below, left, or right of a 2^{nd} point or more points; a measurable distance between the two or more points.
   “Is” is a primary word
   “A” is a primary word
   “Point” is a primary word.
   “Above” is a primary word.
   “Below” is a primary word.
   “Left” is a primary word.
   “Right is a primary word.
   “Of” is a primary word.
   2 is 1 plus 1 (amount); “1” is a primary word

“Plus” is a primary word.

“Is” is a primary word

“Or” is a primary word.
“More” is a primary word—The example method of DMTPCI defining one of the primary words above would be an example of “more” is 2 fingers is more than 1 finger
“Some” is a primary word.
“Measurable” means more than or less than.
“Distance” is a primary word.
“Between” is a primary word. A tautological synonym would be “Separating.”
b. Time is composed of three primary terms: Past, Present, Future. Examples of Past, Present, Future e.g. My father lived in the past. I live now. My children will probably be alive in the future.
   Units of Time are arbitrary designations of Past, Present, Future—i.e. a clock—One tick is arbitrarily defined 1 minute; thus 1 minute by convention (common agreement) becomes the fundamental unit of telling time.
Examples of uses of the definitions of the primary words: Space-Time
   a. Velocity or speed
   b. Acceleration
   c. Force is best understood by examples. I weigh 180 lbs.
      Units of weight are arbitrary. There is in the bureau of standards a certain sized piece of metal that is arbitrarily defined as 1 pound or 1 kilogram.
2. Existence meanings—Is: Subject (I vs. Me; Object, Potential, Actual, Limits or Without Limits (limits meaning traits or characteristics). For example infinite defined under existence refers to a subject not having any limiting characteristics (synonyms: properties, traits, terms, Universals). When “is” is used in a sentence, it is referred to as a copula, connecting the subject to the predicate terms. According to the OED, semantics is “relating to signification or meaning.”
   Types of existence:
Process: For quantity the process of increasing, decreasing. For movement the processes of change in position. For cause—becoming or bring into existence—to be labeled a “cause” the subject bringing something into existence must be not only necessary but sufficient for what is brought into being.
Identity: For geometry, point, line, and extension.
   For time: before, now, after. For other substances, their properties or qualities.
Linkage primary words: “is”, set, subset, equal, under, over, if-then
3. Energy can be Potential or Actual
4. Change can be in time or existence
   The DMPTICI's constructive processes are new means of classification of knowledge. The DMPTICI's definitional method allows one to go in the opposite direction and construct definitions of words from the primary words, see the primary word list attached appendix list A.

The constructive DMPTCI processes can be used in two main areas of knowledge acquisition: 1. The DMPTICI process of knowledge search. 2. The DMPTICI dictionary or library catalogue modification correlated with the usual alphabetical listings. All words can be deconstructed with the aforementioned DMPTICI processes and then listed under their primary properties or terms. For example if a person would type into a DMPTICI constructed software the word “apple,” the DMPTICI software process would immediately deconstruct “apple” to a material object brought into existence by another material object with the properties of a plant. The primary words can also be used to classify or the natural world and then used for searching all words under those primary words.

DMPTICI can be used to optimize the precision of search engine results and therefore used as a calibration tool for online search engines. DMPTICI can also be used as a more precise and clear way of classifying information, allowing for more accurate and precise method of developing search engine algorithms. DMPTICI can delineate customer interest by breaking down categories of customers and their interests into the primary words defining the customers and their interests.

### APPENDIX A

### List of Primary Words

Mirror image; Left; Right; Increase; Decrease; More; Less; More or Greater than; Less than; Unique or Particular; General, Any; Order; Disorder; Quality or Property; Quantity or Amount; One; Add; Subtract; Unity; Absence; Equal; Not; Is (being), Means, Denotes; Join; Separate; Ought vs. Is (What ought to do vs. What is); Define; Include; Exclude; To Think; I; Me; In; Out, On; Over, Above; Under, Below; Of (property related to a thing); Related, Connected; Clockwise; Counter clockwise; Opposite; Same, Identical; Class, Set; Elements (in Class or Set); Whole; Part(s); All; Every; Some; Many; Point; Plane; After; Before; Then; Later; The, unique, Specific; A, not unique; Emphasis; To do; To use; And; Or; If; If-then; Only; Possession: Belong to, related to, part of; 1^{st}, beginning; Response; How; what; when; where; why; Contact; Feelings-Love; Hate; Sad; Happy; Anger; Aware; Unaware; Conscious; Unconscious; Continuous; Discontinuous; To (direction or possession “to itself”); True; False (True be defined as corresponds to what is, also definition of reality; or is not contradicting self-evident truths); Necessary; Sufficient; Complete, Whole; Limited (space or other traits); Unlimited (space or other traits); Is as a verb (is and exists) or being as a noun (A being and existent); Potential; Actual; Change (in time or existence); Parts Of Speech: Subject; Object, Nouns; Verbs; Pronouns; Prepositions; Copulas

1. I claim to have developed a process for making definitions of words clear and precise.
a. This process increase the precision and clarity of the definitions in a dictionary and/or search engine by utilizing a process to precisely understand the meaning of the predicate terms of their historical and/or contextual definitions.
b. The process consists of repeatedly defining the words in a predicate until the primary words are found.
c. I claim to have found a way to understanding the meaning of the primary words found in claim 1. The way to understand the meanings of the primary words is to give examples of what the primary words mean since primary words have no predicate.
d. I claim to have found the primary words. See Appendix A.

2. I claim to have found a new way to classify information: Use the primary words as general classes and put all knowledge under those individual or combined primary word classes.

3. I claim to have found a way to not only clarify and make more precise search engine technology but a way to find classes and subclasses of related words to understand customer interests: Use the primary words found by the contextual method of finding customer interest, e.g. Google invention of page-ranking (historical usage method).
